(19) United States
(12) Patent Application Publication
(10) Pub. No.: US 2012/0033447 A1
(43) Pub. Date: Feb. 9, 2012

(54) BACKLIGHT UNIT

(75) Inventor: Naruo Hashino, Aichi-ken (JP)

(73) Assignee: SONY CORPORATION, Tokyo (JP)

(21) Appl. No.: 13/264,619

(22) PCT Filed: Mar. 10, 2010
(86) PCT No.: PCT/JP2010/001700

§ 371 Date: Oct. 14, 2011

(30) Foreign Application Priority Data
Apr. 22, 2009 (JP) 2009-103700

(51) Int. Cl. G09F 13/08

(52) U.S. Cl. 362/612

(57) ABSTRACT

Provided is a device including a backlight unit including a LED-mounted board having LEDs as a backlight source, a light guide plate to which the LEDs are disposed to face, and which has a light receiving surface to which light from the LEDs incidents and an emission surface from which the incident light is output, and a frame which holds the light guide plate. The frame 14 has a protrusion for positioning which engages the LED-mounted board.

### TECHNICAL FIELD

The present invention relates to a backlight unit using light-emitting diodes (hereinafter, referred to as LEDs) as a backlight source, more specifically, it relates to a backlight unit that enables a LED-mounted board with LEDs as a backlight source fixed on a substrate to be exchangeable, and that enables positioning of the LED-mounted board to be done correctly so as to suppress unevenness of luminance and variation in luminance between before and after replacing.

### BACKGROUND ART

A liquid crystal display device is used for displaying in many electronic devices due to its features such as being light, thin, and low power consumption comparing to a CRT (cathod-ray tube). The liquid crystal display device is to change a direction of liquid crystal molecules aligned in a certain direction by an electric field, and to display images by changing light transmittance of a liquid crystal layer. As the method of displaying by the liquid crystal display device, there are a reflective type and a semi-transmissive type. A reflective type of a liquid crystal display device uses low power consumption since it does not need a backlight, however, the display device becomes hard to see in a dark environment. For this reason, many of the liquid crystal display devices used are transmissive or semi-transmissive types using backlights.

As backlight source, there are a direct-under type arranged on a back surface of a liquid crystal display panel, and a side light type that arranges light source on a side surface of a light guide plate being arranged in a display area on a back surface of a liquid crystal display panel. Backlight source of the side light type reflects light from the light source to the direction of the liquid crystal panel being guided by the light guide plate. For this reason, the backlight source of the side light type has features in which a liquid crystal display device can be thinner than the direct-under type can make, and it can easily equalize the luminance.

Further, many of the backlight sources used are cold cathode discharge tubes and LEDs. Comparing to the cold cathode discharge tube, LEDs have advantages such as being small, low power consumption, a long operating life, free of mercury as cause of environmental contamination, low occurrence of high-frequency noise due to capability for DC lightning, easy to light at low temperature, and so on. For this reason, backlight sources composed of LEDs are often used in small and medium-sized mobile electronic devices, especially, in cellular phone units, portable navigation units, and so on.

On the other hand, backlight sources composed of LEDs have a feature that if a distance to a light receiving surface of a light guide plate is too close, luminance becomes uneven, and if the distance is too far, luminance becomes low. For this reason, as disclosed in the following Patent Literature 1, it is designed so that a predetermined distance can be kept between the LED and the light receiving surface of the light guide plate. In addition, the backlight source disclosed in the following Patent Literature 1 has a LED-mounted board with LEDs fixed on a substrate attached to a metallic frame by double-faced adhesive tape with fine thermal conductivity in order to improve the effectiveness of heat dissipation.

However, although backlight sources composed of LEDs has a long operating life, it has a demerit that resin covering light-emitting devices of LED changes its color across the ages. For this reason, as disclosed in the following Patent Literature 2, there is a structure wherein the a LED-mounted board with LEDs fixed on a substrate can be easily attached and detached. The backlight unit composed of LEDs disclosed by the following Patent Literature 2 adapts a structure wherein an attaching/detaching slot to attach or detach a LED-mounted board is mounted on a bottom surface of the backlight unit, and the attaching/detaching slot is sealed by a cover in a state when the LED-mounted board is attached.

### CITATION LIST

### Patent Literature

Patent Literature 1: JP 2007-163620A
Patent Literature 2: JP 2008-218039A

### SUMMARY OF INVENTION

### Technical Problem

A backlight unit without necessity of exchanging a LED-mounted board can perform positioning of the LED-mounted board at high accuracy since the LED-mounted board can be fixed by double-faced adhesive tape using a fixture or device for positioning, and the LED-mounted board rarely causes backlash due to vibration of vehicle movement or walking. On the contrary, a backlight unit capable of exchanging a LED-mounted board cannot easily attach or detach the LED-mounted board using the fixture or device for positioning of the LED-mounted board, since it is an operation for attaching/detaching the LED-mounted board through a narrow attaching/detaching slot. Moreover, it is difficult to adapt a structure wherein the LED-mounted board is fixed by double-faced adhesive tape when the LED-mounted board needs to be exchanged.

Further, although the structure is capable of exchanging the LED-mounted board as the liquid crystal display device disclosed by the above Patent Literature 2, if the LED substrate is fixed by a simple stopper, the LED-mounted board is not positioned at the predetermined position, therefore, there exists a problem that vibration causes the LED-mounted board to be backlashed to worsen the accuracy of the distance between the light receiving surface of the light guide plate and the LED-mounted board. In addition, the LED-mounted board may move along the direction parallel to the light receiving surface of the light guide plate. In particular, since LED is so called a dot light source, comparing to a linear light source like a cold cathode tube, if it moves even slightly along the direction parallel to the light receiving surface, it gives extremely enormous influence on luminance of light emitted from the light guide plate.

The present invention is made in order to solve such problems of conventional technologies, and it is aimed to provide a backlight unit that enables a LED-mounted board with LEDs as a backlight source fixed on a substrate to be exchangeable, and that enables positioning of the LED-mounted board to be done correctly so as to suppress unevenness of luminance and variation in luminance between before and after replacing.

### Solution to Problem

In order to achieve the above-mentioned object, there is provided a backlight unit of the present invention including a LED-mounted board having light-emitting diodes (hereinafter, referred to as LEDs) as a backlight source, a light guide plate to which the LEDs are disposed to face, and which has a light receiving surface to which light from the LEDs incidents and an emission surface from which the incident light is output, and a frame which holds the LED-mounted board and the light guide plate, and which has an attaching/detaching slot of the LED-mounted board. The LED-mounted board may have an engaging section that engages between the frame and the LED-mounted board each other being formed in the backlight unit held removably in the frame.

The backlight unit of the present invention includes an engaging section that engages between a frame, having a LED-mounted board and a light guide plate, and the LED-mounted board. For this reason, according to the backlight unit of the present invention, although the LED-mounted board makes backlash due to vibration of vehicle movement or walking, displacement can be avoided since an engaging section formed between the frame and the LED-mounted board fixes positioning, and changes in distance between the light receiving surface of the light guide plate and the LED-mounted board can be avoided.

Further, according to the backlight unit of the present invention, the engaging section is preferably made of a hole formed on the LED-mounted board and a protrusion formed in the frame.

According to the backlight unit of the present invention, since the protrusion for positioning formed in the frame engages the hole formed on the LED-mounted board, it becomes possible to avoid displacement of the LED substrate under the condition of further intense vibration, and it becomes possible to further avoid changes in distance between the light receiving surface of the light guide plate and the LED-mounted board. Note that the hole formed on the LED-mounted board may be either a circle, a oval, or a rectangular. Basically, it would be enough if the protrusion for positioning formed in the frame engages tightly the hole formed on the LED-mounted board and it is hard to separate even under the condition of intense vibration.

According to the backlight unit of the present invention, the LED-mounted board is preferably composed of a flexible printed wiring board on which the LED is mounted, and a metallic reinforcing plate to which the flexible printed wiring board is implemented, and the hole is preferably formed on the reinforcing plate.

According to the backlight unit of the present invention, even if the LED-mounted board is likely to be deformed like a printed wiring board, the LED-mounted board is implemented on the metallic reinforcing plate while the protrusion for positioning formed in the frame engages the hole formed on the reinforcing plate, therefore, it is possible to conduct positioning of the LED-mounted board correctly. In addition, since the reinforcing plate is metallic and has a good thermal conductivity, the heat dissipation of LED becomes fine. Therefore, according to the backlight unit of the present invention, it is possible to increase the current to apply to LED, therefore, a brighter backlight unit can be obtained.

According to the backlight unit of the present invention, the frame forms a pressing section that elastically deforms extending from the frame, and the protrusion is formed so as to project from the pressing section.

The pressing section that elastically deforms in the backlight unit of the present invention can form a pressing section composed of a rib having elasticity only by cutting a part of a die for creating a frame if the frame is injection molded, and if the frame is being pressed, it is possible to form a pressing section composed of an arm having elasticity only by applying bending work. For this reason, according to the backlight unit of the present invention, it is possible to easily form a pressing section that elastically deforms in a frame. In addition, according to the backlight unit of the present invention, positioning of the LED-mounted board can be conducted by a simple configuration that implements the LED-mounted board in a frame and that causes the protrusion projecting from the pressing section to joint the hole of the LED-mounted board.

According to the backlight unit of the present invention, the protrusion may have a sloping side surface, and the pressing section may be to be elastically deformed by sliding the LED-mounted board on the sloping side surface of the protrusion when the LED-mounted board is attached or removed.

According to the backlight unit of the present invention, since the protrusion has a slope on which the LED-mounted board slides, to implement the LED-mounted board, the LED-mounted board is to be slide along the slope to automatically elastically deform the pressing section, therefore, the LED-mounted board can be implemented in a frame easily. Further, to remove the LED-mounted board, it is easy to remove the LED-mounted board easily by deforming the pressing section.

### BRIEF DESCRIPTION OF DRAWINGS

FIG. 1 is an exploded perspective view of a liquid crystal display device according to an embodiment;

FIG. 2 is a perspective diagram showing an external appearance of a backlight unit of a liquid crystal display device according to an embodiment;

FIG. 3 is a cross sectional diagram along the line III-III in FIG. 2, and a partially enlarged view thereof;

FIG. 4 is a cross sectional diagram along the line IV-IV in FIG. 2;

FIG. 5A is a cross sectional diagram of a LED-mounted board and a partially enlarged view thereof, and FIG. 5B is a cross sectional diagram of a LED-mounted board in a view from a direction different from FIG. 5A and a partially enlarged view thereof;

FIG. 6A is a perspective diagram showing relationship between a light guide plate and LED light source, and FIG. 6B is a plan view showing an arrangement of a light control unit;

FIG. 7 is a perspective diagram showing a shape of a frame, and partially enlarged view thereof;

FIG. 8 is a perspective diagram showing a shape of a slide, and partially enlarged view thereof;

FIG. 9 is a perspective diagram showing attaching and detaching of a LED-mounted board;

FIG. 10 is a perspective diagram showing attaching and detaching of a slide, and partially enlarged view thereof; and

FIG. 11A is a cross sectional diagram showing a first modified example, and FIG. 11B is a cross sectional diagram showing a second modified example.

### DESCRIPTION OF EMBODIMENTS

Hereinafter, preferred embodiments of the present invention will be described in detail with reference to the embodiments and appended drawings. The following embodiments do not intend to limit the invention to what are described here, but the present invention can be adapted to various modifications within the scope of the appended claims. Note that, the drawings used in this specification for explanation are displayed in different scale size for each layer or member so that each layer or member can fit to a screen so as to be in a perceptible size, and they are not necessarily displayed in proportion as actual size.

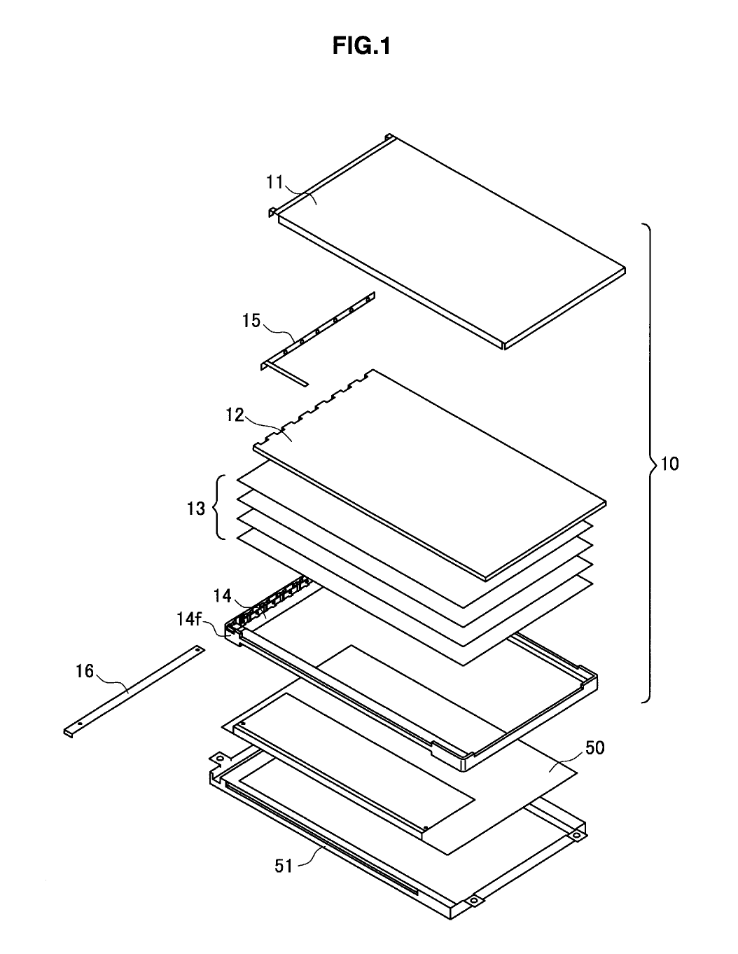

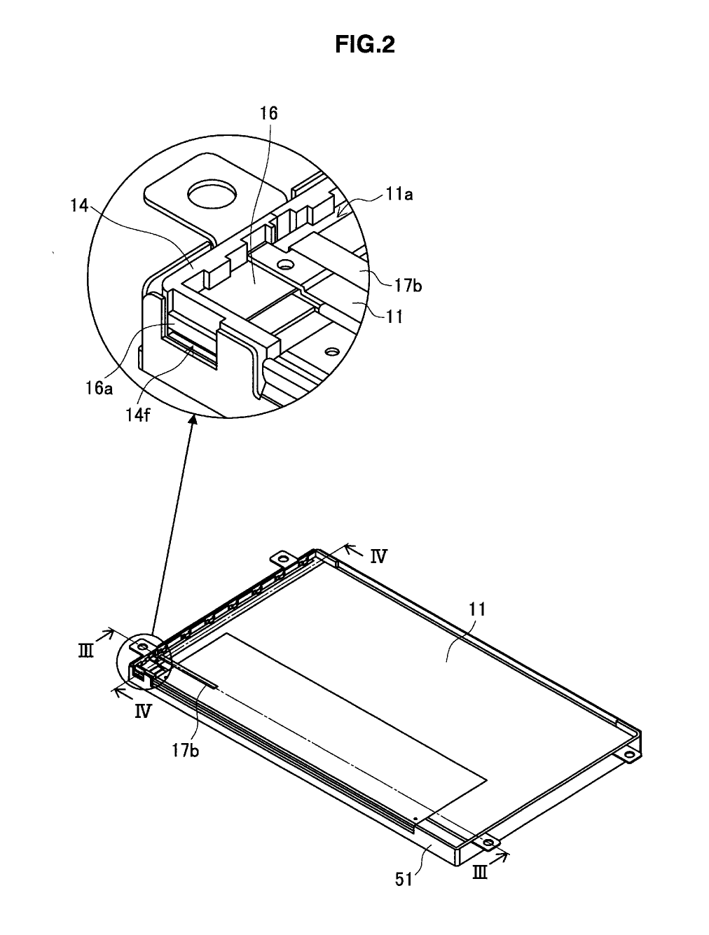

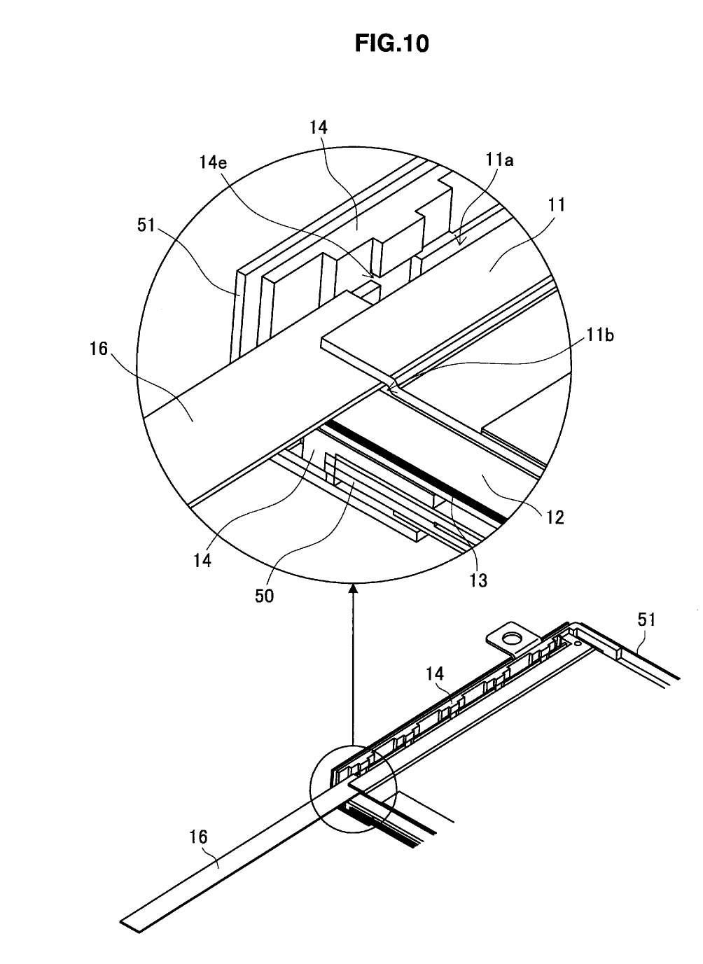

A liquid crystal display device according to the embodiment of the present invention will be explained with reference to FIG. 1 to FIG. 10. A backlight unit 10 that is used for the liquid crystal display device of the present embodiment is, as shown in FIG. 10, arranged on a back surface of a liquid crystal panel 50 which is transmissive or semi-transmissive. The liquid crystal panel 50 is sandwiched between the backlight unit 10 and an upper case 51. On the backlight unit 10, from the back surface of the liquid crystal panel 50, that is, from the upper side of FIG. 1, a lower case 11, a light guide plate 12, an optical sheet 13 and a frame 14 are overlaid. In addition, on the backlight unit 10, a LED-mounted board 15 is held by the frame 14 so as to face the side surface which is the light receiving surface of the light guide plate 12, and is inserted as shown in FIG. 2 so that a slide cover 16 can be slide from a cover insertion slot 14f formed on the side surface of the frame 14.

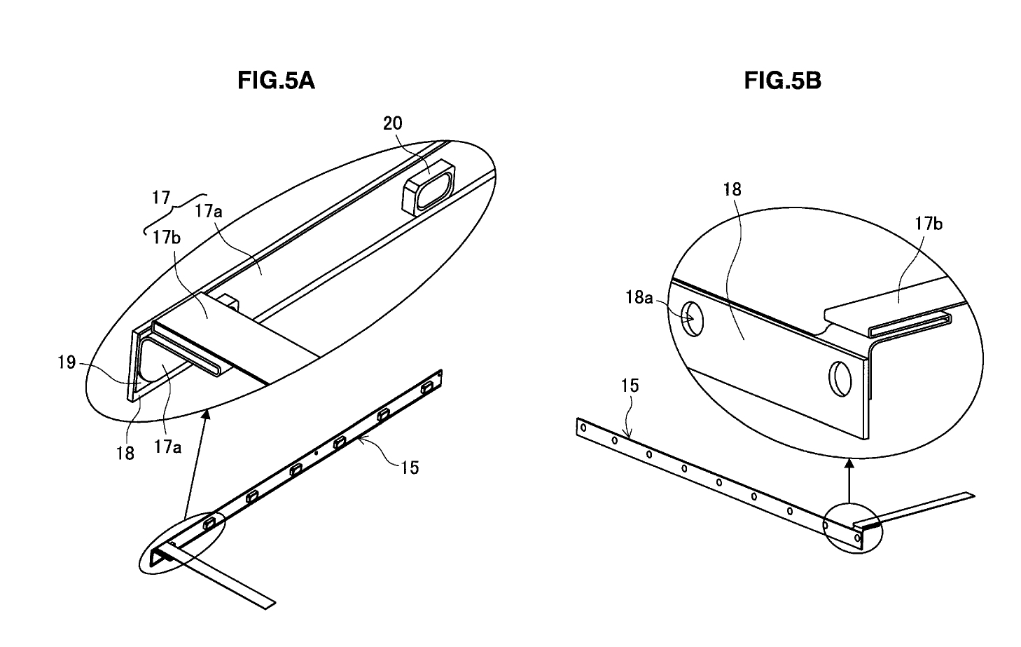

The lower case 11 is, as shown in FIG. 1, formed by extruding a stainless plate. The figure does not shown, however, a white reflection sheet is stuck on inner sides of the lower case 11. As shown in FIG. 5A and FIG. 5B, the LED-mounted board 15 is formed by a flexible printed wiring board 17 fixed on a reinforcing plate 18 by double-faced adhesive tape 19. The flexible printed wiring board 17 is mounted with a plurality of LEDs 20, and composed of a main unit 17a adhered to the reinforcing plate 18, and a connection unit 17b to be connected to an external power source (not shown). The reinforcing plate 18 is created by being pressed from a stainless-steel plate. Further, a hole 18 is placed between two adjacent LEDs 20, and at both ends of the reinforcing plate 18. For the double-faced adhesive tape 19, the one with high thermal conductivity is selected so as to successfully conduct heat of the LED 20 to the reinforcing plate 18. And here, size of the flexible printed wiring board 17 is set to be smaller than size of the reinforcing plate 18 so that an outer periphery of the reinforcing plate 18 locates outside of an outer periphery of the flexible printed wiring board 17.

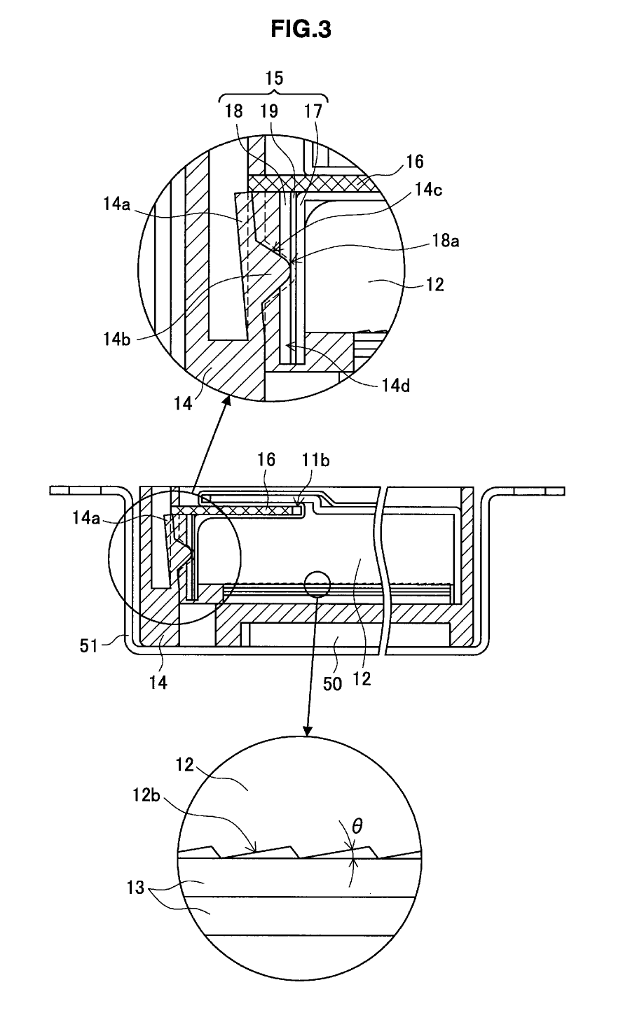

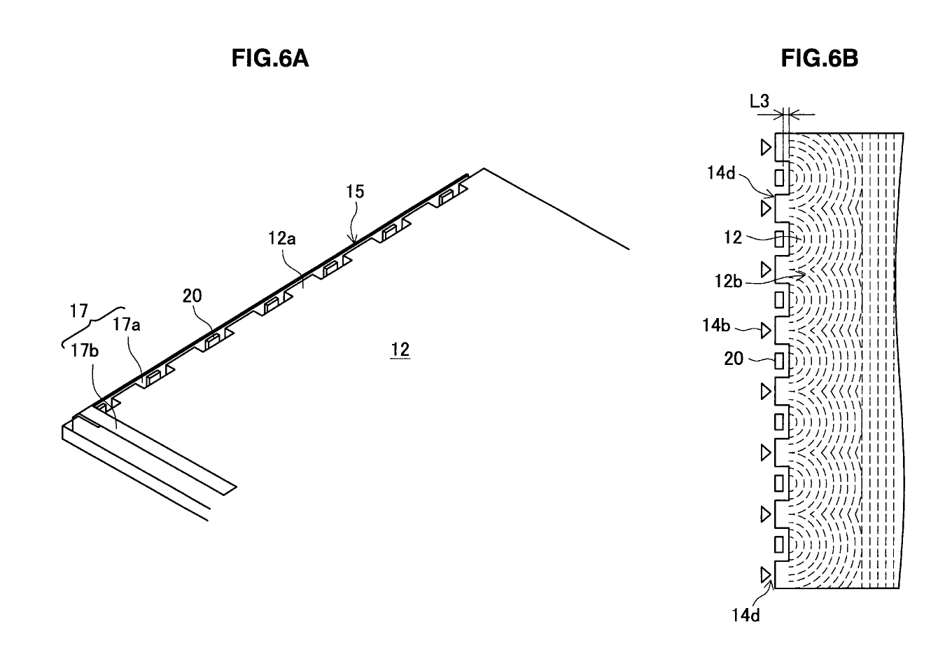

The light guide plate 12 is composed of a transparent acrylic resin (PMMA: polymethyl methacrylate resin) and is created by mold injection. The light guide plate 12 is formed in a rectangular shape of plate, and as shown in FIG. 6A, a side surface where lights incident from LED 20 of the LED-mounted board 15 is extended to the side of LED 20, and has an extension unit 12a that abuts on the main unit 17a of the flexible printed wiring board 17 located between LEDs 20 of the flexible printed wiring board 17. Further, centering a position of the side surface of the flexible printed wiring board corresponding to each LED, a light control unit 12b is formed in a form of ripple. In the light control unit 12b, as shown in the lower enlarged drawing in FIG. 3, a reflection surface whose angle is a predetermined angle θ, about 10 degree, for example, is created in a form of serrate. This light control unit 12b in ripple changes light path of the incident light from a plurality of LEDs 20 at right direction to the incident direction, equalizing luminance at right angle to the incident direction.

The optical sheet 13 is configured from, as shown in FIG. 1, a plurality of sheets, for example four sheets including, a first diffusion sheet that diffuses in order to equalize the luminance, a y-axis prism sheet that focuses light traveling in the direction of y-axis (vertical direction of a display) on the side of the liquid crystal panel 50, a x-axis prism sheet that focuses light traveling in the direction of x-axis (horizontal direction of a display) on the side of the liquid crystal panel 50, and a second diffusion sheet that diffuses in order to equalize the luminance.

A frame 14 is composed of synthetic resin, such as polycarbonate, and is created by mold injection. The frame 14 is in a form of frame in which a central part is widely open so that lights output from the light guide plate 12 can irradiate a display region of the liquid crystal panel 50 without being blocked. Further, according to the backlight unit 10 of the present embodiment, as shown in FIG. 14, the frame 14 joints the lower case 11 and stores the light guide plate 12 and the optical sheet 13. The lower case 11 is slightly shorter than the frame 14 (refer to FIG. 2) so that the LED-mounted board 15 can be attached and detached without removing the lower case 11 from the frame 14, and an attaching/detaching slot 11a is formed between an edge of the lower case 11 and the frame 14.

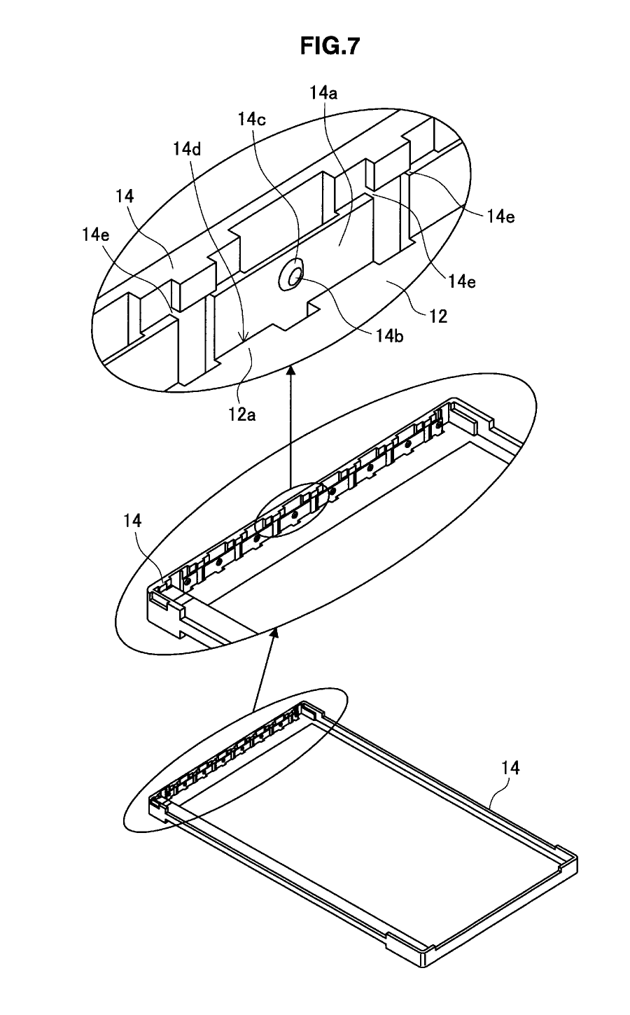

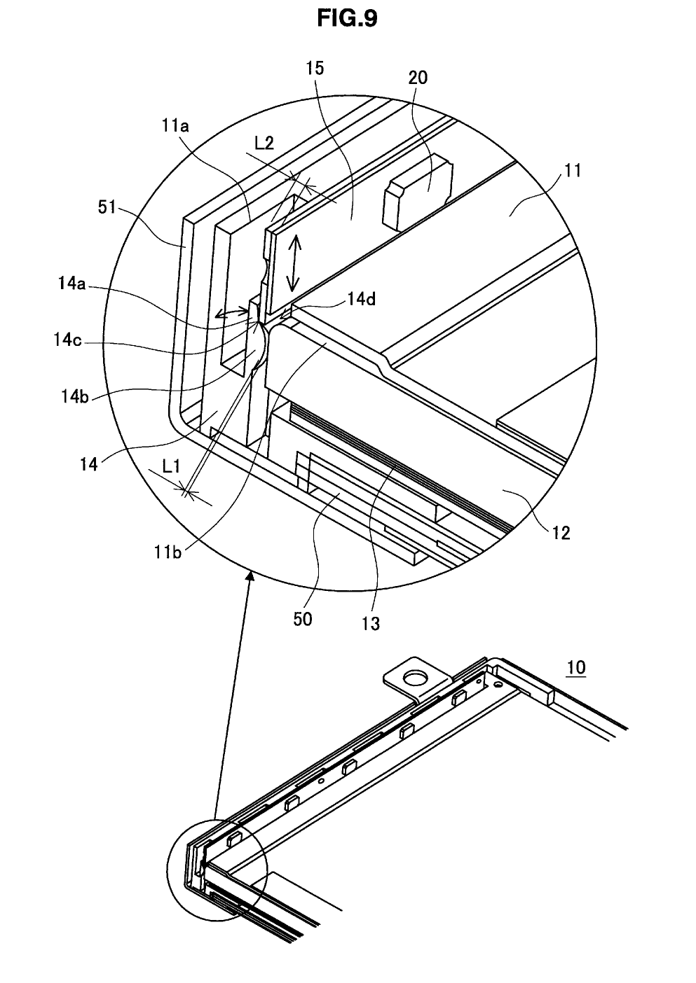

Further, an engaging section is formed so that the frame 14 and the LED-mounted board 15 are mutually engaged. Its specific example shows in the present embodiment, as shown in FIG. 3 and FIG. 7, the frame 14 has a plurality of ribs 14a vertically arranged from a side of surface parallel to the optical sheet 13 of the frame 14 at a position corresponding to a hole 18a of the reinforcing plate 18 of the LED-mounted board 15. Each rib 14a is formed to be narrow and capable of elastically deforming, like a cantilever. In addition, each of ribs 14a have a project 14b that projects from the rib 14a. These ribs 14b joint a plurality of holes 18a formed on the reinforcing plate 18 respectively. The protrusion 14b is in a tapered chevron having a sloping surface 14c. As shown in FIG. 9, in a state before the LED-mounted board 15 is implemented in the frame 14, a gap L1 between the protrusion 14b of the frame 14 and the extension unit 12a of the light guide plate 12 is smaller than a thickness L2 of the flexible printed wiring board 17 added by the reinforcing plate 18.

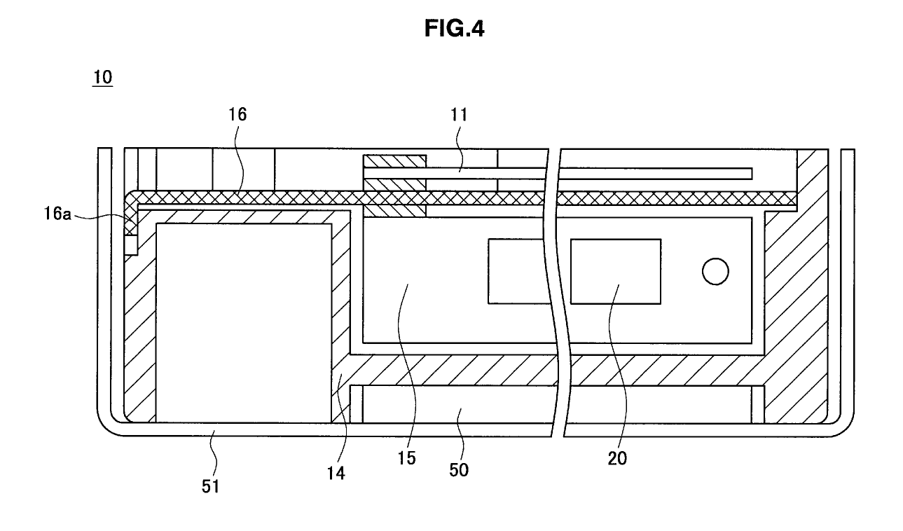

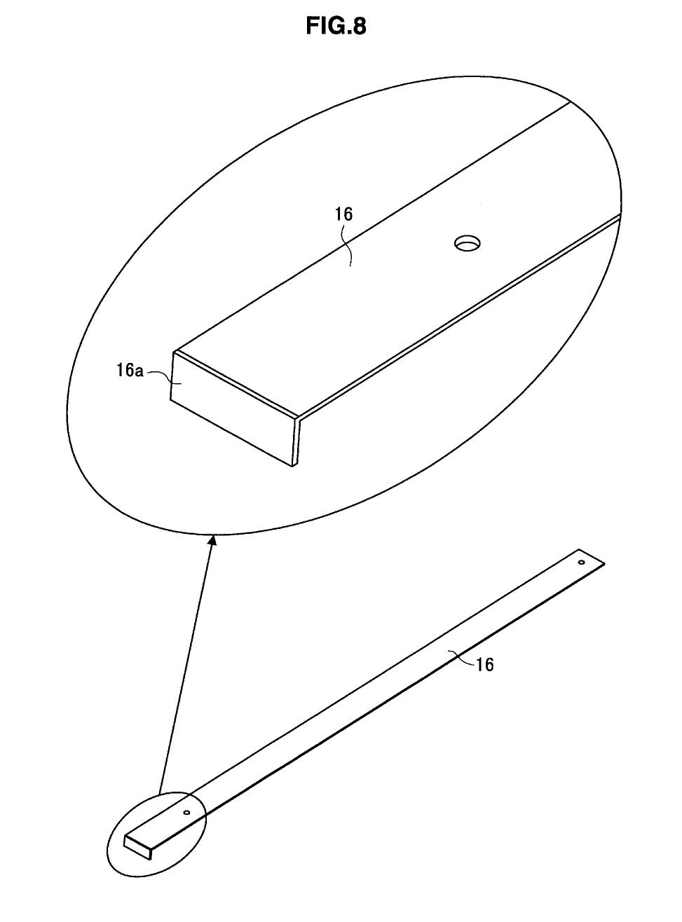

For this reason, when the LED-mounted board 15 is implemented between the frame 14 and the light guide plate 12 from an upper attaching/detaching slot 14d, the outer periphery side of the reinforcing plate 18 slides down the sloping surface 14c of the protrusion 14b so that the rib 14a elastically deforms in the opposite direction of the light guide plate 12, and the protrusion 14b joints the hole 18a. This joint determines the positioning of the LED-mounted board in the frame 14. The position of a LED-mounted board was easy to move in an ordinary backlight unit having a LED-mounted board capable of easily being attached and removed, however, the backlight unit 10 according to this embodiment enables the protrusion 14b joints the hole 18a of the reinforcing plate 18 so that the LED-mounted board 15 can be rigidly and exactly positioned between the frame 14 and the light guide plate 12. In other words, by mutually engaging between the frame 14 and the LED-mounted board 15 in the manner above using the protrusion 14b of the frame 14 and the hole 18a of the reinforcing plate 18 in the LED-mounted board 15, it can be possible to avoid a displacement of LED 20 in the direction (an inserting direction of the slide cover 16 in FIG. 4 and FIG. 8) parallel to the light receiving surface of the light guide plate 12, and a displacement of LED 20 in the vertical direction (a thickness direction of the light guide plate 12 in the cross-sectional diagram in FIG. 3) to the light receiving surface of the light guide plate 12. Especially, unlike a linear light source such as a cold cathode tube, LED 20 is a so-called dot light source and the position of this LED 20 is determined with regard to the light guide plate 12 so that light emitted from the light guide plate 12 has the most high efficiency. Therefore, if LED 20 moves even slightly to the direction parallel to the light receiving surface of the light guide plate 12, or to the vertical direction to the light receiving surface of the light guide plate 12, emitted light from the light guide plate 12 may decrease, however, the present invention may prevent the displacement of LED 20. Especially, in a plurality of LEDs 20 implemented on the LED-mounted board 15, the hole 18a joints the protrusion 14b between the adjacent LEDs 20. Therefore, even near the central part of the LED-mounted board 15 where the displacement of LED 20 in particular likely to occur, the displacement of LED 20 can be avoided.

In a state where the protrusion 14b joints the hole 18a, as shown in FIG. 3, the rib 14a presses the side of the reinforcing plate 18 of the LED-mounted board 15 in the direction of the light guide plate 12 by an elastic deformation. Since the reinforcing plate 18 is rigid, the LED-mounted board 15 is pressed in the direction of the light guide plate 12 evenly, and a gap between LED 20 and the light guide plate 12 is successfully positioned at predetermined position (L3 in FIG. 6B). Therefore, according to the backlight unit 10 of the present embodiment, even though the light guide plate 12 moves due to vibrations such as vehicle movements, walking, or the like, by the elastic deformation in synchronization with it, the LED-mounted board 15 moves in the direction of the light guide plate 12 by the elastic deformation of the rib 14a so as to maintain constant distance between the light guide plate 12 and the LED-mounted board 15.

Further, in the backlight unit 10 of the present embodiment, the light guide plate 12 forms the extension unit 12a (refer to FIG. 6 or FIG. 7) that extends in the direction of the side of the LED-mounted board 15 so as to locate between LEDs 20 of the LED-mounted board 15. When the LED-mounted board 15 is implemented between the frame 14 and the light guide plate 12 from the upper attaching/detaching slot 14d, this extension unit 12a is to abut on the main unit 17a of the flexible printed wiring board 17 on the LED-mounted board 15. Having such configuration, the main unit 17a of the flexible printed wiring board 17 on the LED-mounted board 15 is pressed so as to be sandwiched between the reinforcing plate 18 of the LED-mounted board 15 and the extension unit 12a of the light guide plate 12 so as to be able to maintain constant distance between the LED 20 of the LED-mounted board 15 and the light guide plate 12.

Moreover, since the flexible printed wiring board 17 that fixes LED 20 is fixed on the surface of the stainless-steel reinforcing plate 18 with the double-faced adhesive tape 19 having a fine thermal conductivity, heat generated in LED 20 is to be transferred by conduction to the reinforcing plate 18 and to be cool down. For this reason, according to the backlight unit of the present embodiment, it is possible to apply larger electric current to LED 20 than the backlight unit using ordinary LEDs, so a brighter backlight unit can be obtained.

Note that when conducting desorption of the LED-mounted board 15 from the gap between the frame 14 and the light guide plate 12 via the attaching/detaching slot 11a of the lower cover, as shown in FIG. 9, the LED-mounted board 15 can be pulled out since the hole 18a (refer to FIG. 5) of the reinforcing plate 18 slides down the sloping surface 14c of the protrusion 14b and the rib 14a is to be elastically deformed in an opposite direction of the light guide plate 12 to cancel the joint between the protrusion 14b and the hole 18a.

Further, after implementing the LED-mounted board 15 from the attaching/detaching slot 14b, as shown FIG. 10, the slide cover 16 is inserted from a slide cover insertion slot 14f (refer to FIG. 1 and FIG. 2) of the frame 14, and the attaching/detaching slot 14d of the lower case 11 is to be sealed by sliding to implement the slide cover 16 into a chase 14e formed on a side wall of the LED-mounted board 15 by butting of dies at the time of production of the frame 14, and a gap 11b between the lower case 11 and the light guide plate 12 which is arranged by perpendicular Z-bending of the lower case 11.

At the same time, since one end of the slide cover 16 forms a ligula 16a that is bent into an L-shape, the ligula 16a can seal the slide cover insertion slot 14f (refer to FIG. 1 and FIG. 2) of the frame 14. For this reason, as for the backlight unit 10 of the present embodiment, the attaching/detaching slot 14d of the LED-mounted board 15, the slot which is formed between the lower case 11 and the frame 14, and the slide cover insertion slot 14f formed on the side surface of the frame 14 are sealed at the same by the slide cover 16, and it is possible to prevent an foreign object from entering from the attaching/detaching slot 14d and the slide cover insertion slot 14f. Further, the ligula 16a of the slide cover 16 can be used as a stopper when the slide cover 16 is inserted.

Moreover, as shown in FIG. 3 and FIG. 5, the connection unit 17b of the flexible printed wiring board 17 is bent into an S-shape, passes between the light guide plate 12 and the slide cover 16, and between the slide cover 16 and the lower case 11, so as to be exposed on the outside surface of the lower case 11. Having such configuration, similar to the backlight unit disclosed in the Patent Literature 2 above, a wiring surface of the flexible printed wiring board 17 is not to touch the slide cover 16 so as to prevent disconnection of the flexible printed wiring board 17.

Note that the upper case 51 is also a pressed processed product made of a stainless-steel plate. As shown in FIG. 2, the upper case 51 is in a shape of box, and its central part is widely open so that the display region of the liquid crystal panel 50 can be viewed. Further, the upper case 51 joints the frame 14, and stores the liquid crystal panel 50 between the upper case 51 and frame 14. According to the above-mentioned configuration, lights emitted from LED 20 of the LED-mounted board 15 is to be incident inside the light guide plate via the side surface of the light guide plate 12, to be reflected and diffused at a reflected plate, to be further diffused and focused in the determined direction by the optical sheet 13, and to be emitted on the back surface of the liquid crystal panel 50.

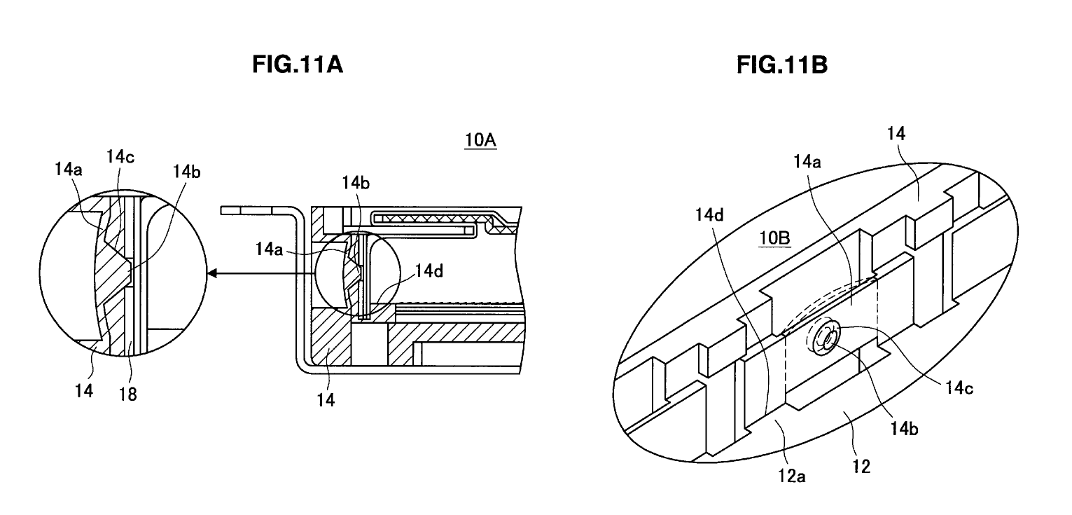

Note that in the backlight unit 10 of the present embodiment described above, the rib 14a formed into the frame 14 is set as a cantilever, therefore it is easy to form this rib 14a since it needs only cutting a part of the die. However, the rib 14a may be the one wherein the hole 18a formed on the reinforcing plate 18 can joint the protrusion 14b formed on the rib 14a, and is not limited to be in a shape of cantilever. For example, it may be in a shape of a vertically-coupled doubly-supported-beam as shown in FIG. 11A as a backlight unit 10A of the first modification, or may be in a shape of a horizontally-coupled doubly-supported beam as shown in FIG. 11B as a backlight unit 10B of the second modification. As far as it is in the shape of the doubly-supported beam, it can apply power, which is parallel to the light receiving surface of the light guide plate 12, to the LED-mounted board 15, the accuracy of positioning becomes more successfully, and it reduces backlash of the LED-mounted board 15. Note that in FIG. 11A and FIG. 11B, same reference signs are assigned for the same part of the structure as the backlight unit 10 of the present embodiment shown in FIGS. 1 to 10, and further detail explanations will be omitted.

Moreover, the above present embodiment has illustrated that the frame 14 and the LED-mounted board 15 engage mutually, using the protrusion 14b of the frame 14 and the hole 18a of the reinforcing plate 18 in the LED-mounted board 15, however, its structure may be the one, for example, where a hole is formed on the side of the frame 14 and a protrusion is formed on the LED-mounted board 15, the engaging between the frame and the LED-mounted board is not limited to the engaging section with a protrusion and a hole, but may be a structure where the both side has a hook so that these hooks are engaging each other.

### REFERENCE SIGNS LIST

10, 10A, 10B backlight unit
11 lower case
11a opening
11b gap
12 light guide plate
12a extension unit (of the light guide plate)
12b optical control unit
13 optical sheet
14 frame
14a rib
14b protrusion
14c sloping surface
14d attaching/detaching slot
14e chase
14f cover insertion slot
15 LED-mounted board
16 slide cover
16a ligula
17 flexible printed wiring board
17a main unit (of the flexible printed wiring board)
17b connection unit (of the flexible printed wiring board)
18 reinforcing plate
18a hole (of the reinforcing plate)
19 double-faced adhesive tape
20 LED
50 liquid crystal panel
51 upper case

1-6. (canceled)

7. A backlight unit comprising:
a LED-mounted board having light-emitting diodes (hereinafter, referred to as LEDs) as a backlight source;
a light guide plate to which the LEDs are disposed to face, and which has a light receiving surface to which light from the LEDs incidents and an emission surface from which the incident light is output; and
a frame which holds the LED-mounted board and the light guide plate, and which has an attaching/detaching slot of the LED-mounted board,
wherein the LED-mounted board has an engaging section that engages between the frame and the LED-mounted board each other being formed in the backlight unit held removably in the frame.

8. The backlight unit according to claim 7,
wherein the engaging section includes a hole formed on the LED-mounted board and a protrusion formed in the frame.

9. The backlight unit according to claim 8,
wherein the LED-mounted board comprising:
a flexible printed wiring board that is mounted by the LEDs; and
a metallic reinforcing plate that is attached with the flexible printed wiring board,
wherein the reinforcing plate forms the hole.

10. The backlight unit according to claim 8,
wherein the frame forms a pressing section that elastically deforms extending from the frame, and the protrusion is formed so as to project from the pressing section.

11. The backlight unit according to claim 10,
wherein the protrusion has a sloping side surface, and
the pressing section is to be elastically deformed by sliding the LED-mounted board on the sloping side surface of the protrusion when the LED-mounted board is attached or removed.

12. The backlight unit according to claim 7,
wherein the LED-mounted board is mounted with a plurality of LEDs, and
the engaging section is formed between the LEDs adjacent to each other.
